(19) United States
(12) Patent Application Publication
(10) Pub. No.: US 2026/0289002 A1
(43) Pub. Date: Sep. 24, 2026

(54) TECHNIQUES FOR SECRET EXTRACTION UTILIZING A GENERATIVE ARTIFICIAL INTELLIGENCE SYSTEM

(71) Applicant: Wiz, Inc., New York, NY (US)

(72) Inventors: Erez HARUSH, Tel Aviv (IL); Daniel LAZAREV, Tel Aviv (IL)

(73) Assignee: Wiz, Inc., New York, NY (US)

(21) Appl. No.: 19/087,929

(22) Filed: Mar. 24, 2025

(51) Int. Cl. G06F 21/62; G06N 3/0475; G06N 3/08

(52) U.S. Cl. CPC G06F 21/6245; G06N 3/0475; G06N 3/08

(57) ABSTRACT

A system and method for training a generative artificial intelligence (AI) model for extracting secrets utilized in a computing environment is presented. The method includes accessing a code repository, wherein the code repository stores code objects representative of resources in a cloud computing environment; processing each code object with a first generative AI model to detect a plurality of potential secrets; extracting the plurality of detected potential secrets from the code objects; and generating a confidence score for each potential secret.

### TECHNICAL FIELD

The present disclosure relates generally to the field of large language models, and specifically to efficiently detecting secrets in a cloud computing environment

### BACKGROUND

As used in computing environments, a secret is any sensitive data such as a credential, password, API key, encryption key, etc., that needs to be protected from unauthorized access. It is essential for secrets to be protected especially when they are shared across various resources in the cloud computing environment. Also when secrets are exposed they pose a direct risk of a cybersecurity threat, vulnerability, data breach, etc., in the cloud computing environment.

There are numerous challenges in protecting secrets in cybersecurity as threats become more advanced. For example, quantum computing threatens the security of secrets as it allows the breakage of key encryption methods that protect personal data such as secrets. Another challenge in protecting secrets is the difficulty of protecting secrets against insiders, or individuals with trusted access as malicious insiders may utilize their own access to obtain unauthorized secret accesses.

Another challenge in protecting secrets includes the lack of organizational enforcement of strong access controls, authentication methods, multi-factor authentication, etc. Especially as organizations share secrets across departments, computing environments, and various hardware components, it gets more challenging to ensure that secrets are kept unexposed. Further misconfigurations and weak access controls can lead to unauthorized access to secrets.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include accessing a code repository, where the code repository stores code objects representative of resources in a cloud computing environment. The method may also include processing each code object with a first generative AI model to detect a plurality of potential secrets. The method may furthermore include extracting the plurality of detected potential secrets from the code objects; and generating a confidence score for each potential secret. Other embodiments of this aspect include corresponding computer systems, apparatus, and computer programs recorded on one or more computer storage devices, each configured to perform the actions of the methods.

Implementations may include one or more of the following features. The method may include: training a second generative AI model based on the plurality of potential detected secrets and corresponding confidence score; and detecting a secret from a new code object utilizing the second generative AI model. The method where training the second generative AI model further may include: fine-tuning the second generative AI model based on the plurality of potential detected secrets and corresponding confidence score. The method may include: generating a representation of the detected secret in a security database, where the security database further includes a representation of the computing environment; and generating a representation of the new code object, connected to the representation of the detected secret. The method may include: initiating a mitigation action in response to detecting the secret in the new code object. The method may include: determining a prevalence of each potential secret; and utilizing the prevalence of each secret to generate an updated confidence score for the potential secret. Implementations of the described techniques may include hardware, a method or process, or a computer tangible medium.

In one general aspect, a non-transitory computer-readable medium may include one or more instructions that, when executed by one or more processors of a device, cause the device to: access a code repository, where the code repository stores code objects representative of resources in a cloud computing environment; process each code object with a first generative AI model to detect a plurality of potential secrets; extract the plurality of detected potential secrets from the code objects; and generate a confidence score for each potential secret. Other embodiments of this aspect include corresponding computer systems, apparatus, and computer programs recorded on one or more computer storage devices, each configured to perform the actions of the methods.

In one general aspect, a system may include a processing circuitry. The system may also include a memory, the memory containing instructions that, when executed by the processing circuitry, configure the system to: access a code repository, where the code repository stores code objects representative of resources in a cloud computing environment. The system may in addition process each code object with a first generative AI model to detect a plurality of potential secrets. The system may moreover extract the plurality of detected potential secrets from the code objects. The system may also generate a confidence score for each potential secret. Other embodiments of this aspect include corresponding computer systems, apparatus, and computer programs recorded on one or more computer storage devices, each configured to perform the actions of the methods.

Implementations may include one or more of the following features. The system where the memory contains further instructions which when executed by the processing circuitry further configure the system to: train a second generative AI model based on the plurality of potential detected secrets and corresponding confidence score; and detect a secret from a new code object utilizing the second generative AI model. The system where the memory contains further instructions that, when executed by the processing circuitry for training the second generative AI model, further configure the system to: fine-tune the second generative AI model based on the plurality of potential detected secrets and corresponding confidence score. The system where the memory contains further instructions which when executed by the processing circuitry further configure the system to: generate a representation of the detected secret in a security database, where the security database further includes a representation of the computing environment; and generate a representation of the new code object, connected to the representation of the detected secret. The system where the memory contains further instructions which when executed by the processing circuitry further configure the system to: initiate a mitigation action in response to detecting the secret in the new code object. The system where the memory contains further instructions which when executed by the processing circuitry further configure the system to: determine a prevalence of each potential secret; and utilize the prevalence of each secret to generate an updated confidence score for the potential secret. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic illustration of a generative Artificial Intelligence (AI) system, implemented in accordance with an embodiment.

FIG. 2 is a flowchart of a method for extracting secrets from code objects, implemented in accordance with an embodiment.

FIG. 3 is a flowchart of a method for generating an updated confidence score for a secret, implemented in accordance with an embodiment.

FIG. 4 is a schematic diagram of a generative AI system, implemented in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a system and method including techniques for secret extraction utilizing a generative AI system.

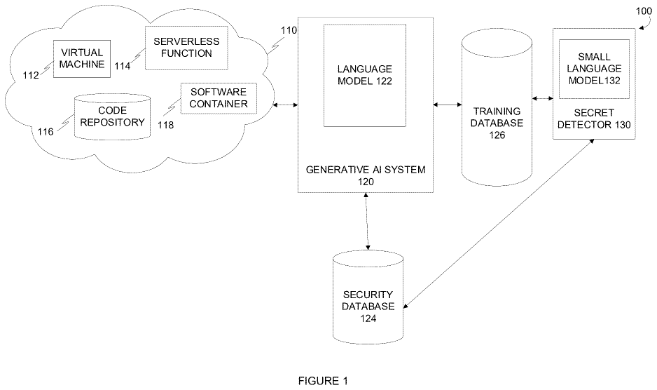

FIG. 1 is a schematic illustration 100 of a generative AI system, implemented in accordance with an embodiment.

In an embodiment, a computing environment 110 is a cloud computing environment, a networked environment, an on-premises environment, a hybrid environment, a combination thereof, and the like. For example, in an embodiment, a cloud computing environment includes a virtual private cloud (VPC), a virtual network (VNet), and the like, deployed on a cloud computing infrastructure. A cloud computing infrastructure is, according to an embodiment, Amazon® Web Services (AWS), Google® Cloud Platform (GCP), Microsoft® Azure, and the like.

In certain embodiments, the cloud computing environment 110 includes a plurality of resources. A resource is, according to an embodiment, a hardware, a bare metal machine, a virtual machine, a virtual workload, a provisioned hardware (or portion thereof, such as a processor, a memory, a storage, etc.), and the like. In certain embodiments, a resource in the cloud computing environment 110 is a virtual machine 112, a software container 118, a serverless function 114, a code repository 116, and the like.

For example, in an embodiment, a virtual machine 112 is implemented as an Oracle® VirtualBox®. In some embodiments, a software container 118 is implemented utilizing a Docker® Engine, a Kubernetes® platform, combinations thereof, and the like. In certain embodiments, a serverless function 114 is implemented in AWS utilizing Amazon Lambda®. In an embodiment, the code repository 116 is configured to store files, code objects, libraries, version control histories, scripts, security keys, secrets, a combination thereof, and the like, of the cloud computing environment 110. In certain embodiments, the code repository 116 includes a version control system (VCS), such as Git® from Github®.

In an embodiment, a generative AI system 120 is communicatively coupled with the computing environment 110. In an embodiment, the generative AI system 120 includes at least a language model 122. In some embodiments, a language model 122 includes a large language model, a small language model, a neural language model, and the like. In an embodiment, for example, the language model 122 includes Claude 3.5 Sonnet, Generative Pretrained Transformer 3 (GPT-3), Bidirectional Encoder Representations from Transformers (BERT), Llama 3.2, Embeddings from Language Models (ELMo), and the like.

In an embodiment, the difference between a large language model and a small language model is that a large language model is greater in size (e.g., has more nodes, has more connections between nodes) and includes a larger amount of parameters in comparison to a small language model which is smaller in size (e.g., has less nodes, has less connections, etc.) and includes a lesser amount of parameters. In some embodiments, a large language model is trained, fine-tuned, and the like, on a vast amount of datasets and a small language model is trained, fine-tuned, and the like, on a smaller more specifically refined dataset. In various embodiments, a smaller language model is more efficient in rapidly generating a response in comparison to a large language model, when utilizing the same hardware.

In various embodiments, the generative AI system 120 is configured to access the code repository 116 of the cloud computing environment 110. In some embodiments, the generative AI system 120 is configured to filter the code objects of the code repository 116 in order to detect at least a secret based on regular expression (regex) matching. In an embodiment, a secret is confidential information that must be protected to prevent unauthorized access, a potential security breach, a cybersecurity threat, and the like.

A secret, for example, includes a password, an encryption key, an Application Programming Interface (API) key, a secure shell (SSH) key, a token, a digital certificate, and the like. In certain embodiments, the generative AI system 120 is configured to extract the detected secret from the code repository 116.

In an embodiment, the generative AI system 120 is configured to utilize the language model 122 to generate a confidence score for the detected secret. In some embodiments, the confidence score is a measurement that the detected secret is in fact an actual secret. In an embodiment, the confidence score is a qualitative score, a quantitative score, a combination thereof, and the like.

In some embodiments, the generative AI system 120 is configured to determine the prevalence of each detected secret. In various embodiments, the prevalence of each secret is proportional to the amount of times a specific code object, tokenized code object, etc., associated with a specific secret is detected in the code repository. In some embodiments, the prevalence of each secret is determined based on the amount of times the code object, tokenized code object, etc., associated with a specific secret, is detected, relative to the total amount of code objects of the code repository.

In some embodiments, a counter of the generative AI system 120 is utilized to count the prevalence or the amount of times a specific code object associated with a secret is detected. In some embodiments, the prevalence of a secret indicates the likelihood of the code object, tokenized code object, being an actual secret.

In various embodiments, the generative AI system 120 is configured to utilize the prevalence of each secret to generate an updated confidence score for the secret. In an embodiment, the generative AI system utilizes its language model 122 to generate an updated confidence score based on the prevalence of a detected secret.

According to an embodiment, the training database 126 is configured to receive training data from the generative AI system 120. In an embodiment, the training database 126 is configured to store the training data generated from the generative AI system 120. In various embodiments, the training data is utilized as a training dataset for the secret detector 130. In some embodiments, training data is a textual dataset of detected secrets, confidence scores, updated confidence scores, the prevalence data of each secret, a combination thereof, and the like. According to an embodiment, the secret detector 130 is configured to detect a secret based on an updated confidence score of the secret, in order to ensure that the detected secret is, in fact, an actual secret.

In some embodiments, the secret detector 130 includes a small language model 132. In an embodiment, the small language model 132 is utilized for detecting secrets based on the updated confidence score as it is trained on a smaller amount of more refined training data. Further, in an embodiment, a small language model 132 is preferred as it efficiently generates a more rapid response than a large language model, when utilizing similar hardware. Alternatively, it is possible to use less hardware (i.e., less processing circuitries, less transistors, etc.) in processing a small language model than a large language model, due for example, to having to process less parameters.

In an embodiment, the security database 124 is configured to store a representation of the outputted secrets from the generative AI system 120 and the secret detector 130. In certain embodiments, the security database 124 is a graph database. In various embodiments, the security database is implemented as a graph database which stores a security graph which provides a representation of the relationships, dependencies, and interactions between the secrets, resources and the like, a representation of the computing environment 110, including virtual machine 112, serverless function 114, a software container 118, code repository 116, and the like.

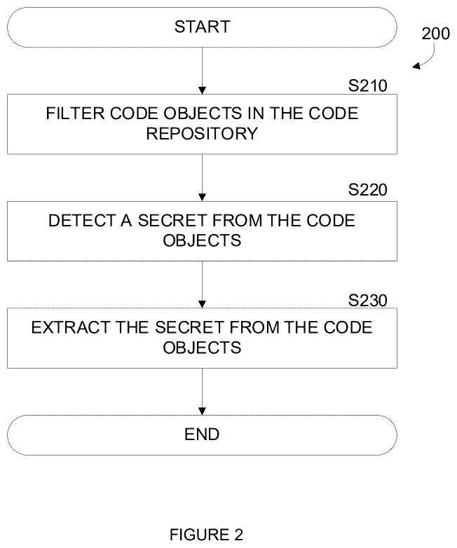

FIG. 2 is a flowchart 200 of a method for extracting secrets from code objects, implemented in accordance with an embodiment. It is advantageous to extract secrets from code objects as this is utilized as training data for a generative AI to detect secrets which in code objects, which then allows for the prevention of the secrets from being exposed or compromised. Thus, accurately detecting secrets helps protect against secret exposure which leads to cybersecurity threats, data breaches, and vulnerabilities in a computing environment.

At S210, code objects in a code repository are filtered. In an embodiment, the code repository is configured to store code objects, files, libraries, software images, version control histories, scripts, security keys, secrets, a combination thereof, and the like, of a cloud computing environment. In an embodiment, the cloud computing environment including resources such as the code repository, virtual machines, software containers, serverless functions, and the like. In some embodiments, the computing environment is communicatively coupled to a generative AI system. In some embodiments, the generative AI system is configured to access the code repository including, for example, its stored code objects. In an embodiment, the code objects are representative of the resources of the cloud computing environment.

In an embodiment, the generative AI system is configured to tokenize each code object input, into tokens, or smaller pieces of code, letters, words, subwords, characters, and the like, in order to process the code objects. In some embodiments, the generative AI system is configured to filter the code object tokens for a specific code object token that indicates a potential secret. For example, in an embodiment, the code objects tokens are filtered to search for the specific code object token “password:1” which indicates the use of a password indicating a potential secret.

In some embodiments, the tokenized code object inputs are processed through the neural network layers of an AI model utilized by the generative AI system to determine the semantic meaning, intent, context, and the like, of the input. In various embodiments, the generative AI system is configured to filter the tokenized code object inputs based on the semantic meaning, intent, context, and the like, of the input, indicating a potential secret. In an embodiment, for example, the tokenized code objects are filtered for tokens, snippets, expressions, and the like, such as “password” and “sensitive data” that semantically indicate a potential secret.

According to an embodiment, the generative AI system is configured to filter the tokenized code objects based on pattern matching utilizing regular expressions (regex). In an embodiment, tokenized code objects, code objects, strings, and the like, are filtered based on whether they match a predefined pattern, code object, string, tokenized code object, etc., that indicates a potential secret. For example, in an embodiment, the generative AI system is configured to filter tokenized code objects based on matching a predefined regex of “password:123” which indicates a potential secret.

At S220, a secret is detected from the code objects. In an embodiment, a secret is a cryptographic data which allows access to a function, an API, an action, a data, a combination thereof, and the like. A secret, for example, includes a password, an encryption key, an Application Programming Interface (API) key, a secure shell (SSH) key, a token, a digital certificate, and the like. In various embodiments, a secret is detected when a tokenized code object, a plurality of code objects, etc., indicating a secret, is detected based on filtering the tokenized code objects.

For example, in an embodiment, the generative AI system is configured to detect a secret in response to the code object token “pass:123” indicating a secret is detected from a filtered search of the specific code object tokens.

In various embodiments, the generative AI system is configured to detect a secret based on detecting at least a tokenized code object that semantically indicates the meaning of a secret. For example, in an embodiment, a secret is detected for the tokenized code object “password” as it semantically indicates sensitive data that should not be shared with unauthorized individuals.

In various embodiments, a secret is detected when at least a tokenized code object matches a predefined regex, pattern, code object, string, tokenized code object, indicating a secret. For example, in an embodiment, a secret is detected in response to a predefined regex of “API_key24” being detected from the tokenized code objects.

At S230, the secret is extracted from the code object. In some embodiments, the detected secrets are extracted from tokenized code objects by parsing the code. In certain embodiments, the detected secrets are extracted from the tokenized code objects by static analysis. In an embodiment, static analysis includes parsing the code objects, tokenized code objects, and the like, without executing the code objects, or portions of the code.

In an embodiment, extracted secrets are utilized as training data on a second AI model. According to an embodiment, a generative AI system is configured to extract a secret, generate a confidence score that the extracted secret is an actual secret (and not, for example, a false positive), and train the second AI to detect secrets based on the extracted secrets and corresponding confidence scores.

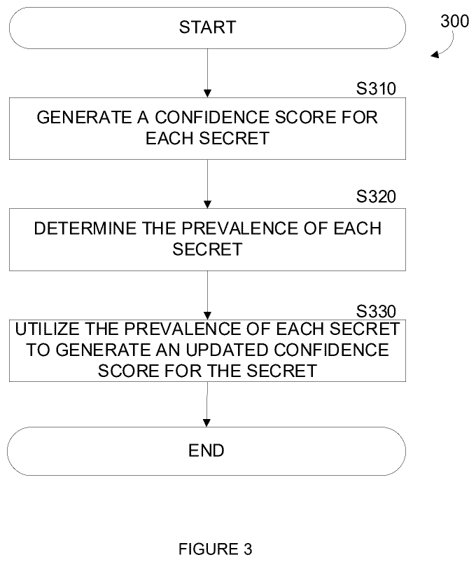

FIG. 3 is a flowchart 300 of a method for generating an updated confidence score for a secret, implemented in accordance with an embodiment. It is advantageous to utilize an updated confidence score for efficient and accurate detection of actual secrets and not false positives. Further, it is advantageous to accurately detect secrets in order to prevent the secrets from being exposed and lead to cybersecurity threats, data breaches, and vulnerabilities, in the cloud computing environment.

At S310, a confidence score is generated for each secret. In an embodiment, a generative AI system utilizes a language model to generate a confidence score which is a measurement (e.g., a probability) of whether the detected secret is in fact an actual secret. In an embodiment, the confidence score is qualitative, quantitative, a combination thereof, and the like. In an embodiment, a quantitative confidence score is a numerical value, a percentage, a statistical value, and the like.

In an embodiment, a qualitative confidence score includes a subjective value to describe the confidence score. For example, in an embodiment in response to a predetermined threshold of a quantitative confidence score of 95% or higher, a qualitative confidence score of “highly likely” is generated for the associated extracted secret.

In various embodiments, the language model of the generative AI system is configured to generate a confidence score for each extracted secret, detected from the code objects, tokenized code objects, and the like. According to an embodiment, a plurality of prompts is generated based on the extracted secret input and used to generate the confidence score. In some embodiments, the language model is configured to select a prompt template from the group of predefined prompt templates based on the extracted secret to generate a confidence score. In an embodiment, the prompt templates are modified based on the extracted secret and its associated tokenized code object, to generate a confidence score.

For example, in an embodiment, for an extracted secret with an associated code object token of “API_key33”, the language model will utilize the prompt template of “provide a confidence score that [detected secret] is a secret utilized in the computing environment including [quantitative value, qualitative value]”, and provide an output of “The confidence score of this detected secret is: 92%, highly likely”.

At S320, a prevalence is determined for each secret. In various embodiments, the prevalence of each secret is the amount of times a specific code object, tokenized code object, etc., associated with a specific secret is detected from the code repository. In some embodiments, the prevalence of each secret is determined based on the amount of times the code object, tokenized code object, etc., associated with a specific secret is detected, relative to the total total amount of code objects, tokenized code objects, of the code repository.

In some embodiments, a counter of the generative AI system is utilized to count the amount of times a specific code object, tokenized code object, and the like, associated with a secret, is detected. In some embodiments, the prevalence of a secret indicates the likelihood of the code object, tokenized code object, being an actual secret. For example, a secret which appears in over 80% (e.g., high prevalence) of code objects, images, etc., which correspond to a deployed virtualization is more likely to be an actual secret than a secret which is only detected in a single software image.

At S330, the prevalence of each secret is utilized to generate an updated confidence score for the secret. In an embodiment, the generative AI system utilizes its language model to generate an updated confidence score based on the prevalence of a detected secret. In various embodiments, the prevalence of each secret is the amount of times a specific code object, tokenized code object, associated with a specific secret is detected from the code repository. In an embodiment, the updated confidence score is a qualitative score, quantitative score, and a combination thereof.

In an embodiment, a quantitative confidence score is a numerical value, a percentage, a statistical value, and the like. In an embodiment, a qualitative confidence score includes subjective value to describe the confidence score.

In various embodiments, the language model of the generative AI system is configured to generate an updated confidence score for each extracted secret based on the prevalence of the secret. According to an embodiment, a plurality of template prompts is generated based on the prevalence and used to generate the updated confidence score.

In some embodiments, the language model is configured to select a prompt template from the group of predefined prompt templates based on the prevalence of the extracted secret to generate an updated confidence score. In an embodiment, the prompt templates are modified based on the extracted secret and its associated tokenized code object, to generate an updated confidence score.

In an embodiment, the updated confidence score, the prevalence, the extracted secrets, the code objects, the tokenized code objects are stored in the training database. In some embodiments, the updated confidence score, the prevalence of each secret, the extracted secrets, the tokenized code objects, are part of the training dataset used to train the secret detector to more accurately extract secrets based on the updated confidence score, prevalence, and a combination thereof.

In various embodiments, the secret detector is configured to extract the training dataset and utilize the updated confidence score, prevalence, extracted secrets, tokenized code objects, code objects, a combination thereof, and the like to more accurately detect a secret. In an embodiment, the secret detector includes a small language model. According to an embodiment, a plurality of template prompts is generated from the small language model based on the updated confidence score from the training dataset.

In some embodiments, the small language model is configured to select a prompt template from the group of predefined prompt templates based on the updated confidence score and detect a secret based on the updated confidence score. In an embodiment, a secret is detected based on the updated confidence score being within a predefined threshold. For example, in an embodiment, in response to an updated confidence score of a specific extracted secret being 97%, the secret detector will detect that this extracted secret is, in fact, an actual secret.

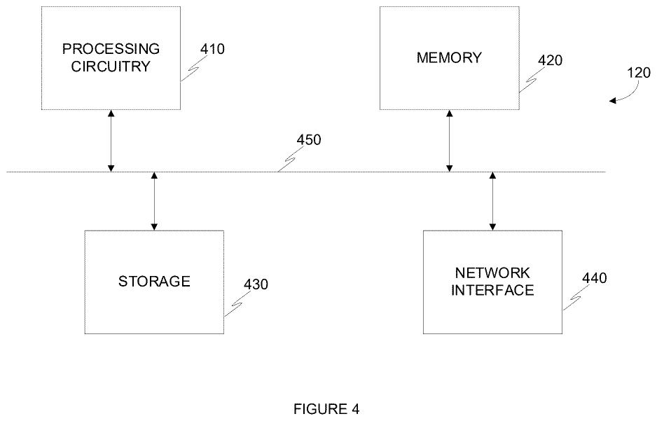

FIG. 4 is an example schematic diagram of a generative AI system 120 according to an embodiment. The generative AI system 120 includes a processing circuitry 410 coupled to a memory 420, a storage 430, and a network interface 440. In an embodiment, the components of the generative AI system 120 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read-only memory, flash memory, etc.), or a combination thereof. In an embodiment, the memory 420 is an on-chip memory, an off-chip memory, a combination thereof, and the like. In certain embodiments, the memory 420 is a scratch-pad memory for the processing circuitry 410.

In one configuration, software for implementing one or more embodiments disclosed herein may be stored in the storage 430, in the memory 420, in a combination thereof, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 is a magnetic storage, an optical storage, a solid-state storage, a combination thereof, and the like, and is realized, according to an embodiment, as a flash memory, as a hard-disk drive, or other memory technology, or any other medium which can be used to store the desired information.

The network interface 440 is configured to provide the generative AI system 120 with communication with, for example, the code repository 116.

It should be understood that the embodiments described herein are not limited to the specific architecture illustrated in FIG. 4, and other architectures may be equally used without departing from the scope of the disclosed embodiments.

Furthermore, in certain embodiments the virtual machine 112, the serverless function 114, the container 118, the code repository 116, and the like may be implemented with the architecture illustrated in FIG. 4. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for training a generative artificial intelligence (AI) model for extracting secrets utilized in a computing environment, comprising:
accessing a code repository, wherein the code repository stores code objects representative of resources in a cloud computing environment;
processing each code object with a first generative AI model to detect a plurality of potential secrets;
extracting the plurality of detected potential secrets from the code objects; and
generating a confidence score for each potential secret.

2. The method of claim 1, further comprising:
training a second generative AI model based on the plurality of potential detected secrets and corresponding confidence score; and
detecting a secret from a new code object utilizing the second generative AI model.

3. The method of claim 2, wherein training the second generative AI model further comprises:
fine-tuning the second generative AI model based on the plurality of potential detected secrets and corresponding confidence score.

4. The method of claim 2, further comprising:
generating a representation of the detected secret in a security database, wherein the security database further includes a representation of the computing environment; and
generating a representation of the new code object, connected to the representation of the detected secret.

5. The method of claim 2, further comprising:
initiating a mitigation action in response to detecting the secret in the new code object.

6. The method of claim 1, further comprising:
determining a prevalence of each potential secret; and
utilizing the prevalence of each secret to generate an updated confidence score for the potential secret.

7. A non-transitory computer-readable medium storing a set of instructions for training a generative artificial intelligence (AI) model for extracting secrets utilized in a computing environment, the set of instructions comprising:
one or more instructions that, when executed by one or more processors of a device, cause the device to:
access a code repository, wherein the code repository stores code objects representative of resources in a cloud computing environment;
process each code object with a first generative AI model to detect a plurality of potential secrets;
extract the plurality of detected potential secrets from the code objects; and
generate a confidence score for each potential secret.

8. A system for training a generative artificial intelligence (AI) model for extracting secrets utilized in a computing environment comprising:
a processing circuitry;
a memory, the memory containing instructions that, when executed by the processing circuitry, configure the system to:
access a code repository, wherein the code repository stores code objects representative of resources in a cloud computing environment;
process each code object with a first generative AI model to detect a plurality of potential secrets;
extract the plurality of detected potential secrets from the code objects; and
generate a confidence score for each potential secret.

9. The system of claim 8, wherein the memory contains further instructions which when executed by the processing circuitry further configure the system to:
train a second generative AI model based on the plurality of potential detected secrets and corresponding confidence score; and
detect a secret from a new code object utilizing the second generative AI model.

10. The system of claim 9, wherein the memory contains further instructions that, when executed by the processing circuitry for training the second generative AI model, further configure the system to:
fine-tune the second generative AI model based on the plurality of potential detected secrets and corresponding confidence score.

11. The system of claim 9, wherein the memory contains further instructions which when executed by the processing circuitry further configure the system to:
generate a representation of the detected secret in a security database, wherein the security database further includes a representation of the computing environment; and
generate a representation of the new code object, connected to the representation of the detected secret.

12. The system of claim 9, wherein the memory contains further instructions which when executed by the processing circuitry further configure the system to:
initiate a mitigation action in response to detecting the secret in the new code object.

13. The system of claim 8, wherein the memory contains further instructions which when executed by the processing circuitry further configure the system to:
determine a prevalence of each potential secret; and
utilize the prevalence of each secret to generate an updated confidence score for the potential secret.
